(19) United States
(12) Patent Application Publication
(10) Pub. No.: US 2012/0139891 A1
(43) Pub. Date: Jun. 7, 2012

(54) Driving Method of Electrophoretic Display Device, Electrophoretic Display Device and Electronic Apparatus

(75) Inventor: Tetsuro Murayama, Nagano-ken (JP)

(73) Assignee: SEIKO EPSON CORPORATION, Tokyo (JP)

(21) Appl. No.: 13/306,246

(22) Filed: Nov. 29, 2011

(30) Foreign Application Priority Data
Dec. 1, 2010 (JP) 2010-268765

(51) Int. Cl. G09G 5/00; G09G 3/34

(52) U.S. Cl. 345/212; 345/107

(57) ABSTRACT

An image rewriting process of rewriting an image displayed by applying any one of a first electric potential or a second electric potential to each of a plurality of pixel electrodes and by moving electrophoretic particles by an electric field generated between the pixel electrodes and a common electrode includes a temperature determining process, and includes a first pulse application process which uses the driving pulse signal with the pulse width being a first width, a low temperature pulse application process, and a second pulse application process which uses the driving pulse signal with the pulse width being a second width, performed at the end. The low temperature pulse application process uses the driving pulse signal with the pulse width being the first width.

### CROSS-REFERENCE TO RELATED APPLICATION

This application claims priority to Japanese Patent Application No. 2010-268765 filed on Dec. 1, 2010. The entire disclosure of Japanese Patent Application No. 2010-268765 is hereby incorporated by herein reference.

### BACKGROUND

1. Technical Field

The present invention relates to a driving method of an electrophoretic display device, an electrophoretic display device, and an electronic apparatus.

2. Related Art

In recent years, a display panel having a memory ability, which is capable of retaining an image even though power is cut off, has been developed and used for an electronic watch or the like. As the display panel having the memory ability, an EPD (electrophoretic display) device, a liquid crystal display device having a memory ability, or the like has been proposed.

In the electrophoretic display device, it is known that flickering occurs if driving is performed using a signal having a long pulse width at an initial driving time when color is rapidly changed. A driving method of an electrophoretic display device disclosed in JP-A-2009-134245 includes a first pulse application process of applying a first pulse signal to a common electrode and a second pulse application process of applying a second pulse signal having a pulse width longer than that of the first pulse signal to the common electrode. The first pulse application process is performed at an initial driving time when color is rapidly changed, and the second pulse application process is performed after the displayed color becomes appropriately close to a desired color, to thereby prevent flickering.

However, in the electrophoretic display device, it is known that a display change occurs according to an environmental temperature. For example, in a case where the environmental temperature at which an electrophoretic display device is used is low (hereinafter, referred to as a low temperature), the viscosity of a dispersion liquid is increased, and thus, the movement amount of electrophoretic particles decreases compared with a case where the environmental temperature is not the low temperature. As a result, even though a voltage, based on the same pulse signal as in a case where the environmental temperature is not the low temperature, is applied to an electrode, it is difficult to obtain a desired color display. Here, if only a signal of a long pulse width is used at the low temperature in order to increase the movement amount of the electrophoretic particles, flickering occurs. Further, when full driving for drawing in an entire display section is performed, a display which causes a sense of discomfort may be visible due to an intermediate image.

### SUMMARY

An advantage of some aspects of the invention is that it provides a driving method of an electrophoretic display device and the like which are capable of performing display without a sense of discomfort by suppressing occurrence of flickering even at a low temperature.

(1) An aspect of the invention is directed to a driving method of an electrophoretic display device including a display section in which an electrophoretic element including electrophoretic particles is disposed between a pair of substrates and a plurality of pixels is arranged, wherein a pixel electrode corresponding to the pixel is formed between one of the substrates and the electrophoretic element and a common electrode which faces the plurality of pixel electrodes is formed between the other one of the substrates and the electrophoretic element. The method includes rewriting an image displayed on the display section by applying a voltage based on a driving pulse signal, in which a first electric potential and a second electric potential are repeated, to the common electrode, by applying any one of the first electric potential and the second electric potential to each of the plurality of pixel electrodes, and by moving the electrophoretic particles by an electric field generated between the pixel electrodes and the common electrode. The rewriting includes: a temperature determination determining whether an environmental temperature is lower than a predetermined threshold temperature; a first pulse application using the driving pulse signal with the pulse width thereof being a first width; a low temperature pulse application performed after the first pulse application in a case where it is determined in the environmental temperature determining process that the environmental temperature is lower than the predetermined threshold temperature; and a second pulse application using the driving pulse signal with the pulse width thereof being a second width, at the end of the rewriting. The low temperature pulse application uses the driving pulse signal with the pulse width thereof being the first width.

According to this aspect of the invention, it is possible to perform display without a sense of discomfort by suppressing flickering even at a low temperature. In this driving method of the electrophoretic display device, since the process (second pulse application) which uses the driving pulse signal having the long second width after the processes (first pulse application and low temperature pulse application) which use the driving pulse signal having the short first width is performed, the occurrence of flickering is suppressed. Further, by performing the low temperature pulse application in the case of the low temperature, an image to be rewritten is smoothly changed. Thus, it is possible to prevent an intermediate image generated in the middle of rewriting from being noticeably viewed, thereby making it possible to perform display without misunderstanding or a sense of discomfort.

(2) In the driving method of the electrophoretic display device, the first width may be 20 ms or less.

With this configuration, by using the driving pulse signal having a short pulse width of 20 ms or less, flickering due to a color change is not visible, thereby making it possible to effectively prevent flickering.

(3) In the driving method of the electrophoretic display device, the first width may be 10 ms or more.

With this configuration, it is possible to prevent the responsiveness from being lowered. That is, if the pulse width is excessively short, the movement amount of the electrophoretic particles is decreased. Then, it is necessary to lengthen the driving time of the first pulse application. In this configuration, by setting the pulse width to 10 ms or more, it is possible to prevent the responsiveness from being lowered.

(4) In the driving method of the electrophoretic display device, the second width may be two or more times the first width.

With this configuration, by setting the second width to two or more times the first width, it is possible to sufficiently move the electrophoretic particles in the second pulse application. As a result, it is possible to enhance contrast.

(5) Another aspect of the invention is directed to an electrophoretic display device including: a display section in which an electrophoretic element including electrophoretic particles is disposed between a pair of substrates and a plurality of pixels is arranged; and a control section which controls the display section. Here, the display section includes: a pixel electrode which is formed between one of the substrates and the electrophoretic element to correspond to the pixel; and a common electrode which is formed between the other one of the substrates and the electrophoretic element to face the plurality of pixel electrodes. The control section includes a temperature determination circuit which determines whether an environmental temperature is lower than a predetermined threshold temperature, and performs an image rewriting control for rewriting an image displayed on the display section by applying a voltage based on a driving pulse signal, in which a first electric potential and a second electric potential are repeated, to the common electrode, by applying anyone of the first electric potential and the second electric potential to each of the plurality of pixel electrodes, and by moving the electrophoretic particles by an electric field generated between the pixel electrodes and the common electrode. The image rewriting control includes: a first pulse application control for using the driving pulse signal with the pulse width thereof being a first width; a low temperature pulse application control performed after the first pulse application control, in a case where the temperature determination circuit determines that the environmental temperature is lower than the predetermined threshold temperature; and a second pulse application control for using the driving pulse signal with the pulse width thereof being a second width, performed at the end of the image rewriting control. Here, the driving pulse signal with the pulse width thereof being the first width is used in the low temperature pulse application control.

According to this aspect of the invention, it is possible to perform display without a sense of discomfort by suppressing flickering even at a low temperature. In this electrophoretic display device, since the process (second pulse application control) which uses the driving pulse signal having the long second width after the processes (first pulse application control and low temperature pulse application control) which use the driving pulse signal having the short first width is performed, the occurrence of flickering is suppressed. Further, by performing the low temperature pulse application control in the case of the low temperature, an image to be rewritten is smoothly changed. Thus, it is possible to prevent an intermediate image generated in the middle of rewriting from being noticeably visible, thereby making it possible to perform display without misunderstanding or a sense of discomfort.

(6) Still another aspect of the invention is directed to an electronic apparatus including the electrophoretic display device as described above.

According to the aspects of the invention, there are provided the driving method of an electrophoretic display device and the like which are capable of performing display without a sense of discomfort by suppressing flickering even at a low temperature, by providing the electrophoretic display device which performs the low temperature pulse application control at the low temperature as an image rewriting control for rewriting an image.

### BRIEF DESCRIPTION OF THE DRAWINGS

The invention will be described with reference to the accompanying drawings, wherein like numbers reference like elements.

FIG. 1 is a block diagram illustrating an electrophoretic display device according to a first embodiment.

FIG. 2 is a diagram illustrating an example of a temperature determination circuit according to the first embodiment.

FIG. 3 is a diagram illustrating a configuration example of pixels of the electrophoretic display device according to the first embodiment.

FIG. 4A is a diagram illustrating a configuration example of an electrophoretic element, and FIGS. 4B and 4C are diagrams illustrating an operation of the electrophoretic element.

FIGS. 5A and 5B are diagrams illustrating a problem of entire surface driving at a low temperature.

FIG. 6A is an example of a display which causes a problem, and FIG. 6B is an example of a display of the present embodiment.

FIG. 7 is a flowchart illustrating a driving method of the electrophoretic display device according to the first embodiment.

FIG. 8 is a flowchart of a sub routine of FIG. 7.

FIGS. 9A and 9B are waveform diagrams according to the first embodiment.

FIGS. 10A and 10B are diagrams illustrating an electronic apparatus according to an application example.

### DESCRIPTION OF EXEMPLARY EMBODIMENTS

Hereinafter, embodiments of the invention will be described with reference to the accompanying drawings. With regard to a modification and an application, the same reference numerals are given to the same configuration as in a first embodiment, and detailed description thereof will be omitted.

### 1. First Embodiment

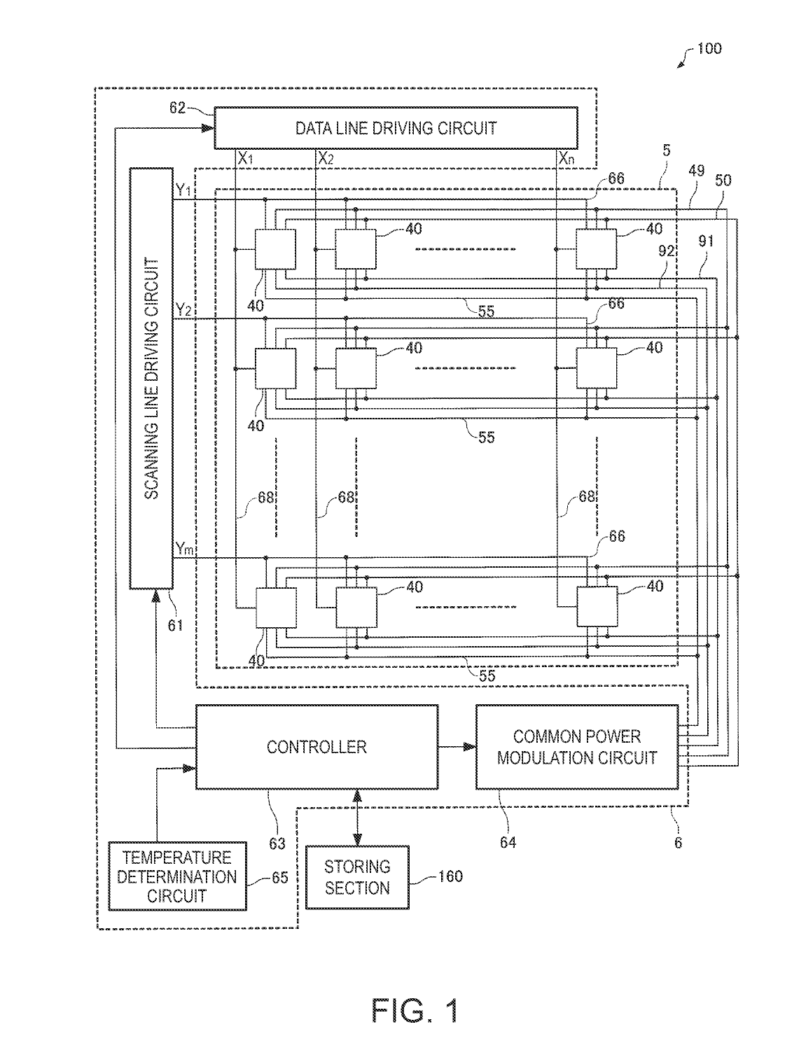

The first embodiment of the invention will be described with reference to FIG. 1 to FIG. 9B.

### 1.1. Electrophoretic Display Device

### 1.1.1. Configuration of Electrophoretic Display Device

FIG. 1 is a block diagram illustrating an electrophoretic display device 100 of an active matrix drive type according to the present embodiment.

The electrophoretic display device 100 includes a control section 6, a storing section 160 and a display section 5. The control section 6 controls the display section 5, and includes a scanning line driving circuit 61, a data line driving circuit 62, a controller 63, a common power modulation circuit 64, and a temperature determination circuit 65. The scanning line driving circuit 61, the data line driving circuit 62, the common power modulation circuit 64, and the temperature determination circuit 65 are connected to the controller 63, respectively. The controller 63 generally controls these sections on the basis of image signals or the like read from the storing section 160 or sync signals supplied from the outside. The control section 6 may be configured to include the storing section 160. For example, the storing section 160 may be a memory which is built into the controller 63.

Here, the storing section 160 may be an SRAM, a DRAM or a different memory, and stores at least data (image signal) about images displayed on the display section 5. Further, information to be controlled by the controller 63 may be stored in the storing section 160.

A plurality of scanning lines 66 which extends from the scanning line driving circuit 61 and a plurality of data lines 68 which extends from the data line driving circuit 62 are formed in the display section 5, and a plurality of pixels 40 is formed to correspond to intersections thereof.

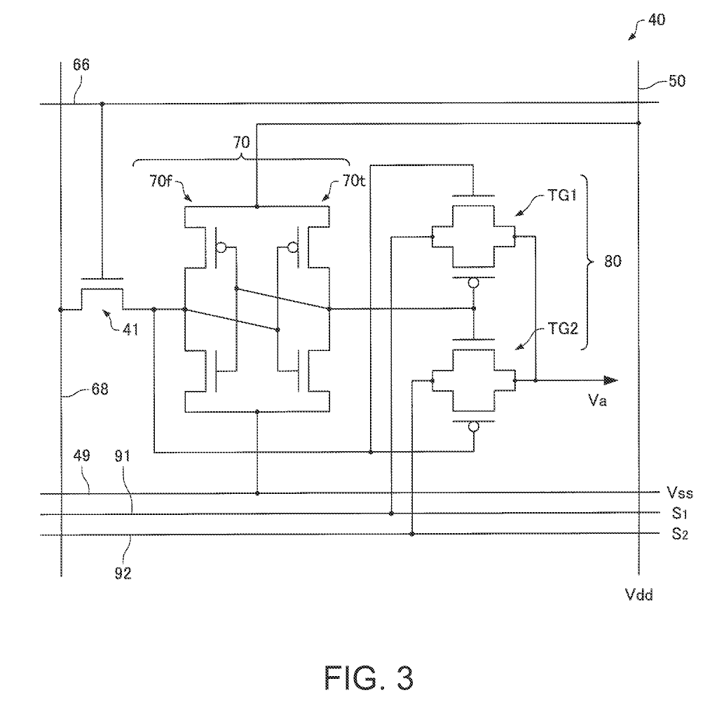

The scanning line driving circuit 61 is connected to respective pixels 40 by m scanning lines 66 (Y₁, Y₂, . . . , Yₘ). By sequentially selecting the scanning lines 66 from the first line to the m-th line under the control of the controller 63, the scanning line driving circuit 61 supplies a selection signal which regulates an on-timing of a driving TFT 41 (see FIG. 3) which is disposed in a pixel 40.

The data line driving circuit 62 is connected to the respective pixels 40 by n data lines 68 (X₁, X₂, . . . , Xₙ). The data line driving circuit 62 supplies, to the pixel 40, an image signal which regulates image data of one bit corresponding to each of the pixels 40, under the control of the controller 63. In the present embodiment, if image data “0” is regulated, an image signal of a low level is supplied to the pixel 40, and if image data “1” is regulated, an image signal of a high level is supplied to the pixel 40.

A low electric potential power line 49 (Vss), a high electric potential power line 50 (Vdd), a common electrode wiring 55 (Vcom), a first pulse signal line 91 (S₁) and a second pulse signal line 92 (S₂), which extend from the common power modulation circuit 64, are disposed in the display section 5. The respective wirings are connected to the pixel 40. The common power modulation circuit 64 generates a variety of signals which are supplied to the respective wirings under the control of the controller 63, and also performs electric connection and disconnection of the respective wirings (high impedance, Hi-Z).

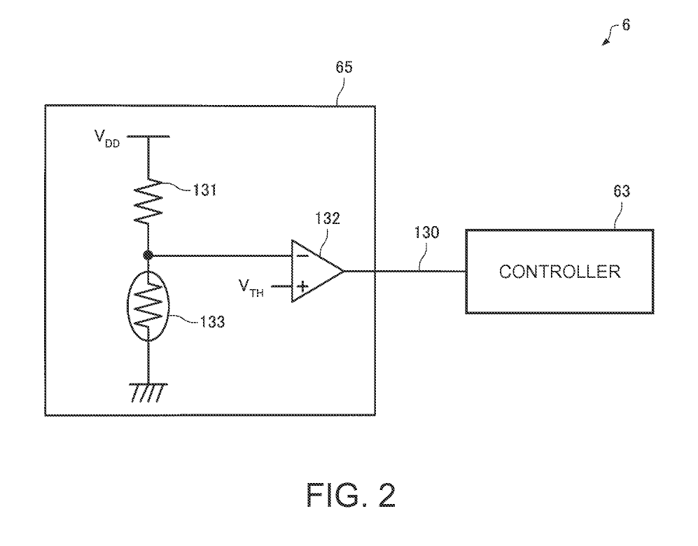

FIG. 2 illustrates a specific example of the temperature determination circuit 65 included in the control section 6 according to the present embodiment. The temperature determination circuit 65 measures an environmental temperature at which the electrophoretic display device is used, and outputs a temperature determination signal 130 according to whether the measured environmental temperature is lower than a threshold temperature to the controller 63. The temperature determination circuit 65 may be disposed outside the control section 6, and may output only the temperature determination signal 130 to the controller 63.

The temperature determination circuit 65 uses a resistor connected to a ground electric potential among divided resistors as a thermistor 133. The thermistor 133 is an NTC (Negative Temperature Coefficient) thermistor, for example, and a resistance value thereof becomes small according to a temperature increase. Another resistor 131 connected to the side of a high electric potential (for example, V_{DD}) has a fixed resistance value.

The temperature determination circuit 65 compares a threshold electric potential V_{TH} corresponding to the threshold temperature with a resistance-divided electric potential by a comparator 132, and outputs the temperature determination signal 130 to the controller 63. For example, in a case where the environmental temperature is lowered to be lower than the threshold temperature, the resistance-divided electric potential input to a non-inverting input terminal of the comparator 132 becomes higher than the threshold temperature V_{TH}. At this time, the temperature determination circuit 65 outputs the temperature determination signal 130 of a low level. In a case where the environmental temperature is lower than the threshold temperature, that is, it is a low temperature, if full driving is performed, there may be a problem in that an unfavorable display is visible by an intermediate image. The controller 63 of the electrophoretic display device 100 according to the present embodiment solves this problem by changing a driving method, according to whether the temperature determination signal 130 is a low level (low temperature) or a high level (temperature other than the low temperature).

### 1.1.2. Circuit Configuration of Pixel Portion

FIG. 3 is a diagram illustrating a circuit configuration of the pixel 40 in FIG. 1. The same reference numerals are given to the same wirings as in FIG. 1, and detailed description thereof will be omitted. Further, description about the common electrode wirings 55 which are common in all pixels will be omitted.

The driving TFT (Thin Film Transistor) 41, a latch circuit 70, and a switch circuit 80 are disposed in the pixel 40. The pixel 40 has a configuration of an SRAM (Static Random Access Memory) type which holds an image signal as an electric potential by the latch circuit 70.

The driving TFT 41 is a pixel switching element including an N-MOS transistor. Agate terminal of the driving TFT 41 is connected to the scanning line 66, and a source terminal thereof is connected to the data line 68. Further, a drain terminal thereof is connected to a data input terminal of the latch circuit 70. The latch circuit 70 includes a transfer inverter 70t and a feedback inverter 70f. Power voltage is supplied to the inverters 70t and 70f from the low electric potential power line 49 (Vss) and the high electric potential power line 50 (Vdd).

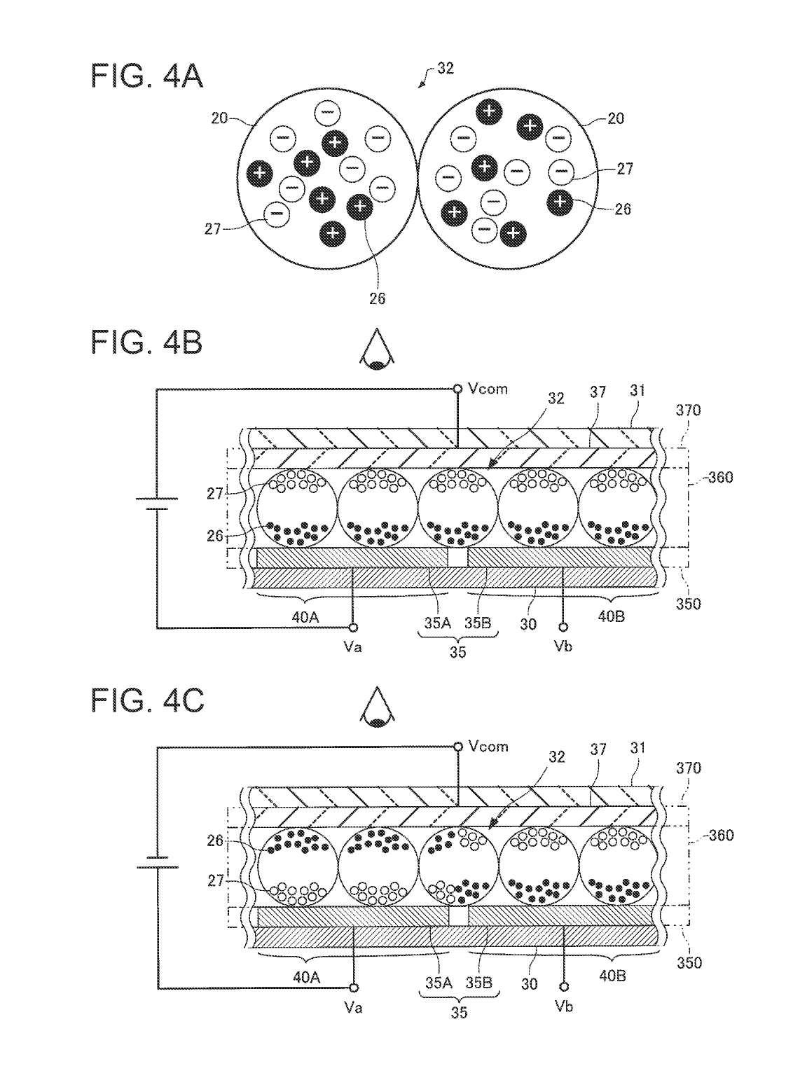

The switch circuit 80 includes transmission gates TG1 and TG2, and outputs a signal to a pixel electrode 35 (see FIGS. 4B and 4C) according to the level of the pixel data stored in the latch circuit 70. Here, “Va” represents an electric potential (signal) supplied to the pixel electrode of one pixel 40.

If the image data “1” (image signal of the high level) is stored in the latch circuit 70 and the transmission gate TG1 is turned on, the switch circuit 80 supplies a signal S₁ as Va. On the other hand, if the image data “0” (image signal of the low level) is stored in the latch circuit 70 and the transmission gate TG2 is turned on, the switch circuit 80 supplies a signal S₂ as Va. With such a circuit configuration, the control section 6 can control the electric potential (signal) supplied to the pixel electrode of each pixel 40. The circuit configuration of the pixel 40 is an example, and thus is not limited to that shown in FIG. 3.

### 1.1.3. Display Method

The electrophoretic display device 100 according to the present embodiment employs an electrophoretic method of a two-particle system microcapsule type. If a dispersion liquid is colorless and transparent and electrophoretic particles are black or white, at least two colors can be displayed using two colors of black and white as base colors. Here, it is assumed that the electrophoretic display device 100 can display black and white as base colors. Further, displaying a pixel which displays black with white or displaying a pixel which displays white with black is referred to as inversion.

FIG. 4A is a diagram illustrating a configuration of an electrophoretic element 32 according to the present embodiment. The electrophoretic element 32 is disposed between a device substrate 30 and an opposing substrate 31 (see FIGS. 4B and 4C). The electrophoretic element 32 has a configuration in which a plurality of microcapsules 20 is arranged. The microcapsule 20 includes, for example, a colorless and transparent dispersion liquid, a plurality of white particles (electrophoretic particles) 27, and a plurality of black particles (electrophoretic particles) 26. In the present embodiment, for example, it is assumed that the white particles 27 are negatively charged and the black particles 26 are positively charged.

FIG. 4B is a partial cross-sectional diagram of the display section 5 of the electrophoretic display device 100. The device substrate 30 and the opposing substrate 31 support therebetween the electrophoretic element 32 in which the microcapsules 20 are arranged. The display section 5 includes a driving electrode layer 350 which includes a plurality of pixel electrodes 35, on a side of the device substrate 30 which faces the electrophoretic element 32. In FIG. 4B, the pixel electrode 35A and the pixel electrode 35B are shown as the pixel electrodes 35. It is possible to supply an electric potential to each pixel by the pixel electrode 35 (for example, Va or Vb). Here, a pixel which has the pixel electrode 35A is referred to as a pixel 40A, and a pixel which has the pixel electrode 35B is referred to as a pixel 40B. The pixel 40A and the pixel 40B are two pixels which correspond to the pixel (see FIGS. 1 and 3).

On the other hand, the opposing substrate 31 is a transparent substrate, and an image is displayed on the side of the opposing substrate 31 in the display section 5. The display section 5 includes a common electrode layer 370 which includes a planar common electrode 37, on a side of the opposing substrate 31 which faces the electrophoretic element 32. The common electrode 37 is a transparent electrode. The common electrode 37 is an electrode which is common to all pixels, differently from the pixel electrode 35, and is supplied with an electric potential Vcom.

The electrophoretic element 32 is disposed in an electrophoretic display layer 360 which is disposed between the common electrode layer 370 and the driving electrode layer 350, and the electrophoretic display layer 360 forms a display area. According to an electric potential difference between the common electrode 37 and the pixel electrode (for example, 35A or 35B), it is possible to display a desired color for each pixel.

In FIG. 4B, the electric potential Vcom on the common electrode side is an electric potential which is higher than an electric potential Va of the pixel electrode of the pixel 40A. At this time, since the white particles 27 which are negatively charged are pulled to the side of the common electrode 37, and the black particles 26 which are positively charged are pulled to the side of the pixel electrode 35A, when viewed, the pixel 40A displays white.

In FIG. 4C, the electric potential Vcom on the common electrode side is an electric potential which is lower than the electric potential Va of the pixel electrode of the pixel 40A. At this time, contrarily, since the black particles 26 which are positively charged are pulled to the side of the common electrode 37, and the white particles 27 which are negatively charged are pulled to the side of the pixel electrode 35A, when viewed, the pixel 40A displays black. Since the configuration of FIG. 4C is the same as that of FIG. 4B, description thereof will be omitted. Further, in FIGS. 4B and 4C, Va, Vb and Vcom are described as fixed electric potentials, but in reality, Va, Vb and Vcom are pulse signals in which their electric potentials are changed with time.

### 1.2. Driving Method of Electrophoretic Display Device

### 1.2.1. Full Driving

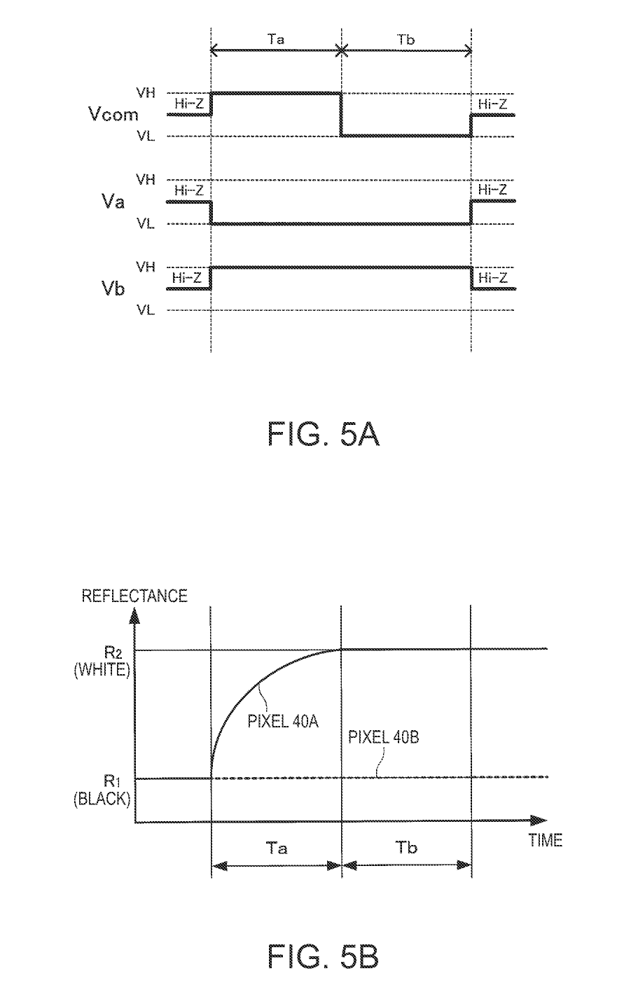

Here, in a case where images are rewritten by the electrophoretic display device, full driving for drawing in the entire display section may be performed. FIG. 5A is a waveform diagram illustrating the full driving in the electrophoretic display device 100 according to the present embodiment. Since Va, Vb and Vcom are the same as in FIGS. 4B and 4C, detailed descriptions thereof will be omitted.

A driving pulse signal Vcom which repeats a first electric potential VH and a second electric potential VL is supplied to the common electrode. A signal Va which has the second electric potential VL is supplied to the pixel 40A, and a signal Vb which has the first electric potential VH is supplied to the pixel 40B. The pixel 40A and the pixel 40B are two pixels shown in FIG. 4B, for example, and are all displayed with black before a voltage based on the driving pulse signal Vcom is applied. Here, the first electric potential is set to the high electric potential VH and the second electric potential is set to the low electric potential VL, but these may be reversed.

As shown in FIG. 5A, Vcom includes the first electric potential and the second electric potential which are sequentially applied, and the respective pulse widths thereof are Ta and Tb. Here, in the case of the full driving, Ta and Tb are the same. In a section (corresponding to Ta in the figure) where Vcom is VH, a pixel which is a rewriting target is changed to white, and in a section (corresponding to Tb in the figure) where Vcom is VL, the pixel which is the rewriting target is changed to black. In this example, Vcom is in a driving stop state (high impedance state) after the second electric potential is applied, but Vcom may be a signal which repeats the first electric potential and the second electric potential a plurality of times.

FIG. 5B illustrates color change in the pixel 40A and the pixel 40B, in this example. A reflectance R₁ corresponds to black, and a reflectance R₂ corresponds to white. In the pixel 40A, since Va is continuously set to VL, an electric field is generated only in the section (corresponding to Ta in the figure) where Vcom is VH, where black is changed to white. Thereafter, the white color is maintained. In the pixel 40B, since Vb is continuously set to VH, an electric field is generated only in the section (corresponding to Tb in the figure) where Vcom is VL. However, since the pixel 40B is black from the beginning, the reflectance is not changed and the black color is maintained as it is. In the full driving, the rewriting is performed by assigning a signal which has VH or VL to all the pixels of the display section according to an image to be displayed.

### 1.2.2. Problems in Full Driving at Low Temperature

Here, at low temperature, the movement amount of the electrophoretic particles is reduced. Thus, it is necessary to lengthen the pulse widths Ta and Tb so that the time when the electric field acts on the electrophoretic particles become long. However, if the pulse widths Ta and Tb are lengthened, for example, an intermediate image after Ta passes is visible. The intermediate image refers to only an image in which black is changed to white. As shown later, an unfavorable display is visible due to the intermediate image. The low temperature refers to a case where an environmental temperature at which the electrophoretic display device 100 is used, for example, is lower than 10° C. However, the low temperature may be determined with reference to an internal temperature of the display section 5 or the like, or may have a threshold temperature other than 10° C.

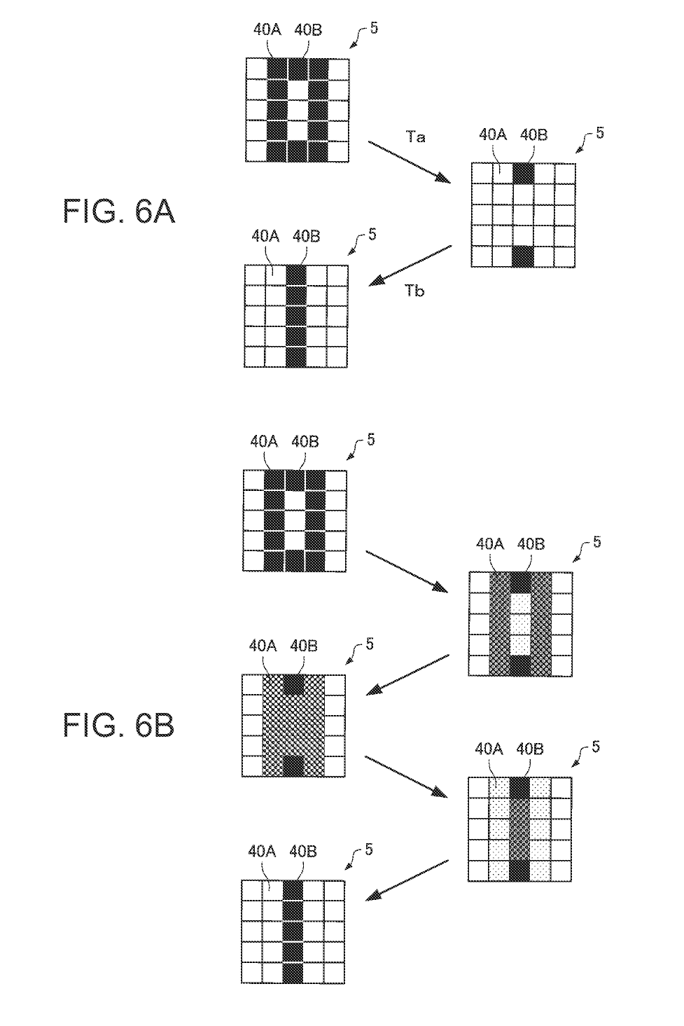

FIG. 6A illustrates an example of a case where an image displayed on the display section 5 is rewritten by the full driving at the low temperature. Here, an area of 5×5 pixels including the pixel 40A and the pixel 40B is extracted and displayed as the display section 5. Ta and Tb are the same as in FIGS. 5A and 5B, which are used as times corresponding to pulse widths (in this example, Ta=Tb=500 ms). The pixel 40A and the pixel 40B are the same as in FIG. 5B. The pixel 40A is changed from black to white, and the pixel 40B maintains black as it is.

FIG. 6A illustrates a case where an original image (0) is rewritten to a new image (1) by the full driving using Vcom of a long pulse width at the low temperature. At this time, after 500 ms elapses, an intermediate image as shown in the right figure of FIG. 6A is displayed on the display section 5, and then is changed to a new image over 500 ms. The intermediate image includes a common portion of the original image (0) and the new image (1), but there is a possibility that it is misunderstood as a colon (:). Further, even without such a misunderstanding, since the intermediate image is visible, a user may feel a sense of discomfort such that a different character is inserted during rewriting. In the case of a temperature other than the low temperature, even though the intermediate image is displayed, this is visible for a very short time, which does not cause a problem.

Thus, if the original image is smoothly changed to the new image at the low temperature, the intermediate image which may be visible as a different character is not displayed and the image change becomes natural, and thus, the user does not feel a sense of discomfort. For example, FIG. 6B illustrates an example of a case where the image is smoothly changed. Images which are changed in the order of arrows are displayed on the display section 5, the original image (0) gradually becomes close to white, and the new image (1) gradually becomes close to black. At this time, there is a light intermediate color at the beginning, but the new image (1) is continuously visible in the rewriting process. Thus, display is possible without a sense of discomfort without the intermediate image being misunderstood as a different character.

In the electrophoretic display device 100 according to the present embodiment, the following driving method is performed so that the original image is smoothly changed to the new image at the low temperature. In a case where Vcom is a signal which repeats the first electric potential and the second electric potential a plurality of times, in addition to the problem of the unfavorable display as shown in FIG. 6A, a problem of flickering occurs. According to the following driving method of the electrophoretic display device, it is possible to suppress flickering.

### 1.2.3. Flowchart

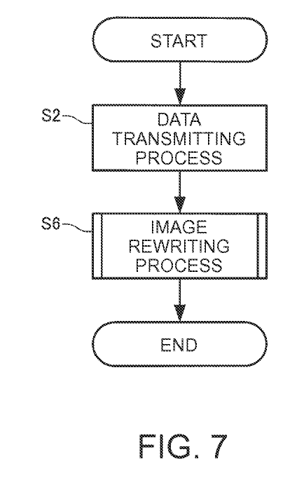

FIG. 7 is a flowchart of a main routine illustrating the driving method of the electrophoretic display device according to the first embodiment.

When the controller 63 (see FIG. 1) rewrites an image to be displayed on the display section 5, firstly, the controller 63 performs a data transmitting process of obtaining an image signal from the storing section 160 and controlling the scanning line driving circuit 61 and the data line driving circuit 62 to transmit the data to each pixel (S2).

Next, the controller 63 performs an image rewriting process of rewriting the image to be displayed on the display section 5 on the basis of the image signal by the common power modulation circuit 64 (S6). In the image rewriting process, in order to perform a favorable display by suppressing flickering at the low temperature, the following sub routine flowchart is given.

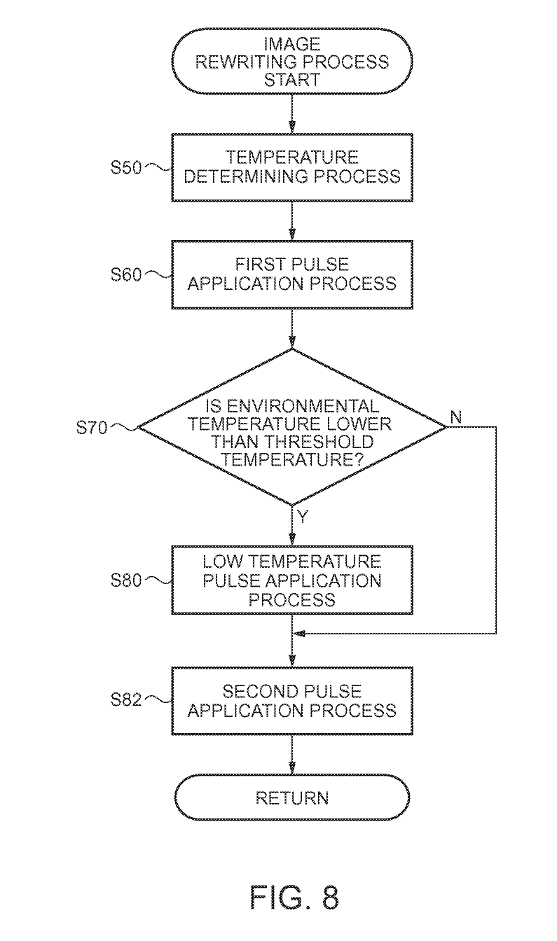

FIG. 8 is a flowchart of a sub routine of the image rewriting process S6 in the first embodiment. In the present embodiment, the image rewriting process step S6 includes a temperature determining process S50, a first pulse application process S60, a low temperature pulse application process S80, and a second pulse application process S82. Here, a pulse signal supplied to the common electrode is referred to as a “driving pulse signal”.

The temperature determining process S50 is a process where the controller 63 determines whether the environmental temperature is a low temperature on the basis of a temperature determining signal 130.

Even though the environmental temperature is not the low temperature, the first pulse application process S60 is performed. In the first pulse application process S60, a voltage based on the first pulse signal with the pulse width (Ta or Tb in FIG. 5A) being the first width is applied as the driving pulse signal.

In the case of a temperature other than the low temperature, the first pulse application process S60 is performed to prevent flickering. That is, a rapid change is suppressed by using a signal of a short pulse width (first width), at an initial driving time when color change is rapidly performed, and thus, flickering does not occur. In the case of the low temperature, in addition to the flickering prevention, the original image is smoothly changed to the new image, so that the intermediate image (see FIG. 6A) which may cause misunderstanding is not displayed.

Thereafter, in a case where it is determined in the temperature determining process S50 that the environmental temperature is the low temperature (S70: Y), the low temperature pulse application process S80 is performed. In the low temperature pulse application process S80, a voltage based on the first pulse signal is applied in a similar way to the first pulse application process S60. In the case of the low temperature, the viscosity of a dispersion liquid is increased, and thus, the movement amount of electrophoretic particles is decreased. As a result, compared with a case other than the low temperature, it is necessary to lengthen the time when the electric field acts on the electrophoretic particles. Here, if a voltage based on the driving pulse of the long pulse width is applied, flickering may occur. Accordingly, it is preferable that the voltage based on the first pulse signal having the first width be applied so that the reflectance becomes close to an arrival reflectance until flickering is not noticeable. In the electrophoretic display device, even if a voltage is continuously applied between the common electrode and the pixel electrodes, the reflectance is saturated. The arrival reflectance refers to the saturated reflectance.

In the low temperature pulse application process S80, in addition to the smooth change of the rewritten image, the driving time of the first pulse application process S60 is lengthened at the low temperature, so that the reflectance becomes close to the arrival reflectance until flickering does not occur even though the subsequent second pulse application process S82 is performed.

Further, at the end of the image rewriting process S6, the second pulse application process S82 is performed. In the case of a temperature other than the low temperature, the second pulse application process S82 is performed subsequent to the first pulse application process S60 (S70: N). In the second pulse application process S82, a voltage based on the second pulse signal with the pulse width being the second width is applied as the driving pulse signal. The second width is longer than the first width of the first pulse signal, and the time when the electric field acts on the electrophoretic particles is long. Thus, it is possible to increase the arrival reflectance indicating white or to decrease the arrival reflectance indicating black, to thereby improve the contrast. At this time, flickering does not occur.

In this driving method of the electrophoretic display device, since the process (second pulse application process) which uses the driving pulse signal having the long second width is performed after the processes (first pulse application process and low temperature pulse application process) which use the driving pulse signal having the short first width, the occurrence of flickering is suppressed. Further, by performing the low temperature pulse application process in the case of the low temperature, an image to be rewritten is smoothly changed. Thus, it is possible to prevent an unfavorable display by an intermediate image from being noticeably visible.

In the present embodiment, in order to solve the problem that the unfavorable display is visible at the low temperature, the low temperature pulse application process S80 is added, but since the voltage based on the first pulse signal is applied in the low temperature pulse application process S80 in a similar way to the first pulse application process S60, it is not necessary to add a circuit for generating a new pulse signal. Accordingly, it is possible to solve the problem at the low temperature without a significant increase in the circuit size.

In the second pulse application process S82, the second pulse signal at the low temperature or at the temperature other than the low temperature may be changed. At this time, it is possible to further improve the contrast. Further, the temperature determining process S50 may determine whether the environmental temperature is a high temperature, for example. Further, in a case where it is determined that the environmental temperature is the high temperature, the pulse width (first width) of the first pulse signal may be adjusted to be shortened. At this time, it is possible to quicken the response at the image rewriting time.

### 1.2.4. Example of Waveform Diagram and Color Change

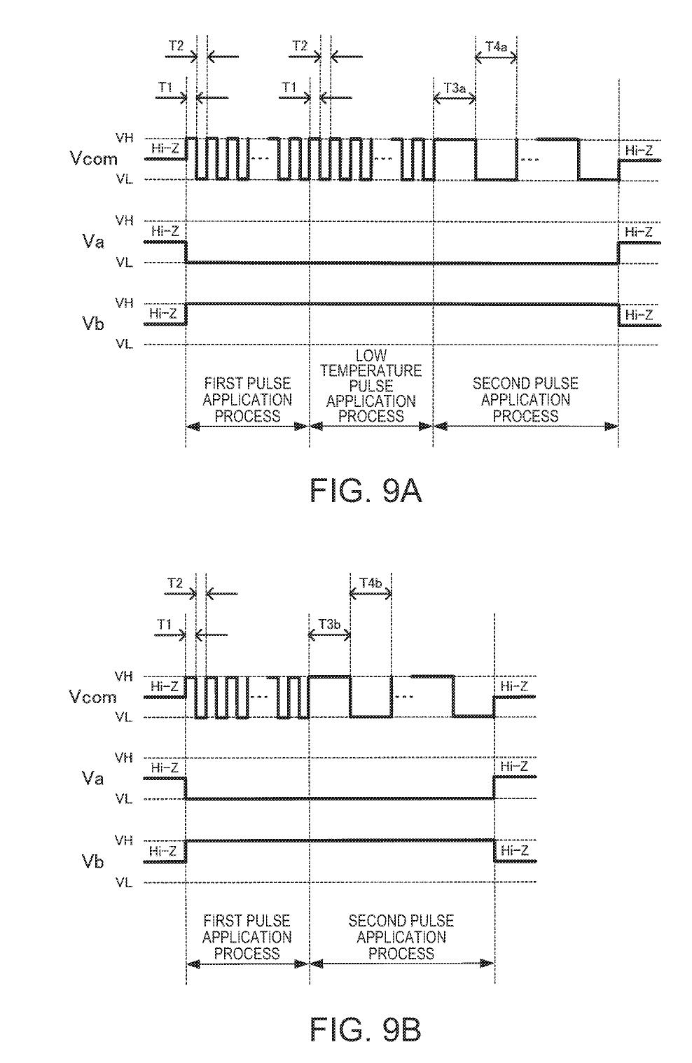

FIGS. 9A and 9B illustrate waveform diagrams when the full driving is performed by the driving method according to the first embodiment. In the figures, since Va, Vb, Vcom, VH and VL are the same as those of FIG. 5A, detailed descriptions thereof will be omitted. Further, names of the processes in the figures correspond to those of the processes of the flowchart in FIG. 8.

As shown in FIGS. 9A and 9B, the signal Va which has the electric potential VL is supplied to the pixel 40A, and the signal Vb which has the electric potential VH is supplied to the pixel 40B. In this example, the pixel 40A is changed from black to white, and the pixel 40B is maintained black as it is.

FIG. 9A is a waveform diagram at the low temperature (for example, 10° C. or lower), in which the first pulse application process, the low temperature pulse application process and the second pulse application process are performed. Here, a pulse width T1 in the first pulse application process and the low temperature pulse application process is the same as a pulse width T2, and a pulse width T3a in the second pulse application process is the same as a pulse width T4a. Accordingly, only the pulse widths T1 and T3a will be described hereinafter.

In the first pulse application process, the first pulse signal in which T1 (first width) is 10 ms or longer and ms or shorter, for example, is used. It has been experimentally confirmed that the occurrence of flickering can be suppressed in a case where T1 is 20 ms or shorter. However, there is a possibility that the driving time in the first pulse application process is lengthened and the response at the rewriting time is delayed in a case where T1 is shorter than 10 ms. For this reason, it is preferable that T1 be in the above-described range. As a specific example, the first pulse signal which repeats a pulse having T1 (and T2) of 20 ms thirty times may be used.

In the low temperature pulse application process, the same first pulse signal as in the first pulse application process may be used. As a specific example, the first pulse signal which repeats a pulse having T1 (and T2) of 20 ms twenty times may be used. Through the low temperature pulse application process, it is possible to be close to the arrival reflectance until flickering does not occur in the subsequent second pulse application process, while smoothly changing the original image to the new image.

In the second pulse application process, the second pulse signal in which T3a (second width) is 40 ms or longer, for example, is used. The second pulse application process increases the arrival reflectance indicating white or decreases the arrival reflectance indicating black, to thereby improve the contrast. Thus, in order to lengthen the time when the electric field acts on the electrophoretic particles, T3a is set to be at least two or more times T1. As a specific example, the second pulse signal which repeats a pulse having T3a (and T4a) of 600 ms six times may be used.

T1, T3a and the like may be given as a function of the threshold temperature. For example, the threshold temperature may be set by the controller 63, and the temperature determination circuit 65 may select an appropriate threshold voltage V_{TH} according to the threshold temperature to output the temperature determining signal 130. Further, the controller 63 may change T1 to 10 ms from 20 ms, or change T3a to 200 ms from 600 ms, for example, according to the set threshold temperature. Further, the controller 63 may perform adjustment so that the number of repetitions of the first pulse signal and the second pulse signal is changed.

FIG. 9B is a waveform diagram of a case other than the low temperature, in which the low temperature pulse application process is not performed. Thus, the driving time of the pulse signal is short, and it is thus possible to quicken the response at the image rewriting time compared with the low temperature time.

At this time, the pulse width T3b (=T4b) of the second pulse signal may be the same as T3a, or may be set to be shorter than T3a in order to quicken the response at the image rewriting time. Since others are the same as in the case of FIG. 9A, description thereof will be omitted.

As shown in the waveform diagrams of FIGS. 9A and 9B, in the present embodiment, since the process (second pulse application process) which uses the driving pulse signal having the long second widths T3a and T3b is performed after the processes (first pulse application process and low temperature pulse application process) which use the driving pulse signal having the short first width T1, the occurrence of flickering is suppressed. Further, as shown in FIG. 9A, by performing the low temperature pulse application process in the case of the low temperature, an image to be rewritten is smoothly changed. Thus, it is possible to prevent an unfavorable display by an intermediate image from being noticeably visible.

### 2. Application example

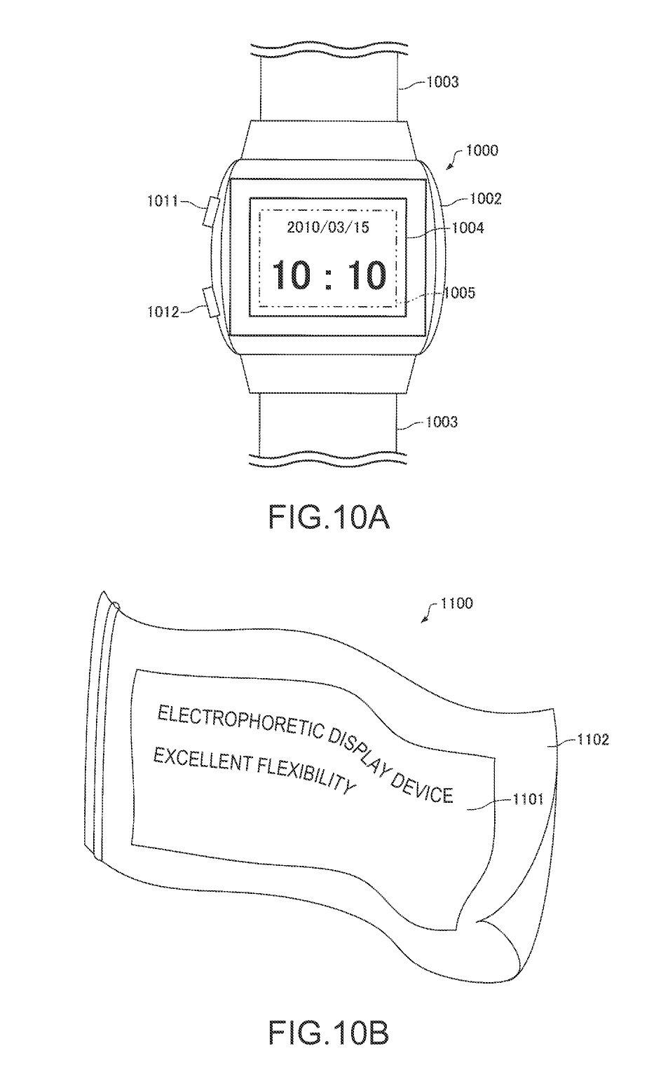

An application example of the invention will be described with reference to FIGS. 10A and 10B. The electrophoretic display device 100 may be applied to a variety of electronic apparatuses.

For example, FIG. 10A is a front view of a wrist watch 1000 which is a kind of electronic apparatus. The wrist watch 1000 includes a watch case 1002 and a pair of bands 1003 connected to the watch case 1002. At a front portion of the watch case 1002, a display portion 1004 which includes the electrophoretic display device 100 is disposed, and the display section 1004 performs a display 1005 which includes a time display. At a side portion of the watch case 1002, two operation buttons 1011 and 1012 are disposed. A variety of display types such as time, calendar, alarm or the like may be selected as the display 1005 by the operation buttons 1011 and 1012.

Further, FIG. 10B is a perspective view of an electronic paper 1100 which is a kind of electronic apparatus, for example. The electronic paper 1100 has flexibility, and includes a display area 1101 which includes the electrophoretic display device 100 and a main body 1102.

The electronic apparatus which includes the electrophoretic display 100 can perform a favorable display with the occurrence of flickering being suppressed at a low temperature.

### 3. Others

In the above-described embodiments, the electrophoretic display device is not limited to an electrophoretic display device of a two-particle system of black and white which uses black and white particles, but may be an electrophoretic display device of a single particle system of blue, white or the like, or may be an electrophoretic display device having a color combination other than the black and white combination. Further, the driving method is not limited to the active matrix type, and may be a segment type.

Further, the invention is not limited to the electrophoretic display device, and the driving method may be applied to a display device with a memory ability. For example, the driving method may be applied to an ECD (electrochromic display), a ferroelectric liquid crystal display, a cholesteric liquid crystal display or the like.

The invention is not limited to the exemplary embodiments, and includes substantially the same configuration (for example, configuration having the same functions, methods and results or configuration having the same objects and effects) as the configuration described in the embodiments. Further, the invention includes a configuration in which sections which are not essential in the configuration described in the embodiments are replaced. Further, the invention includes a configuration having the same effects as the configuration described in the embodiments or a configuration capable of achieving the same objects. Further, the invention includes a configuration in which any known technology is added to the configuration described in the embodiment.

What is claimed is:

1. A driving method of an electrophoretic display device including a display section in which an electrophoretic element including electrophoretic particles is disposed between a pair of substrates and a plurality of pixels is arranged, wherein a pixel electrode corresponding to the pixel is formed between one of the substrates and the electrophoretic element and a common electrode which faces the plurality of pixel electrodes is formed between the other one of the substrates and the electrophoretic element, the method comprising:
rewriting an image displayed on the display section by applying a voltage based on a driving pulse signal, in which a first electric potential and a second electric potential are repeated, to the common electrode, by applying any one of the first electric potential and the second electric potential to each of the plurality of pixel electrodes, and by moving the electrophoretic particles by an electric field generated between the pixel electrodes and the common electrode,
wherein the rewriting includes
a temperature determination determining whether an environmental temperature is lower than a predetermined threshold temperature;
a first pulse application using the driving pulse signal with the pulse width thereof being a first width;
a low temperature pulse application using the driving pulse signal with the pulse width thereof being the first width, after the first pulse application, in a case where it is determined in the environmental temperature determining that the environmental temperature is lower than the predetermined threshold temperature; and
a second pulse application using the driving pulse signal with the pulse width thereof being a second width, at the end of the rewriting.

2. The method according to claim 1,
wherein the first width is 20 ms or less.

3. The method according to claim 1,
wherein the first width is 10 ms or more.

4. The method according to claim 1,
wherein the second width is two or more times the first width.

5. An electrophoretic display device comprising:
a display section in which an electrophoretic element including electrophoretic particles is disposed between a pair of substrates and a plurality of pixels is arranged; and
a control section which controls the display section,
wherein the display section includes
a pixel electrode which is formed between one of the substrates and the electrophoretic element to correspond to the pixel; and
a common electrode which is formed between the other one of the substrates and the electrophoretic element to face the plurality of pixel electrodes,
wherein the control section includes a temperature determination circuit which determines whether an environmental temperature is lower than a predetermined threshold temperature, and performs an image rewriting control for rewriting an image displayed on the display section by applying a voltage based on a driving pulse signal, in which a first electric potential and a second electric potential are repeated, to the common electrode, by applying any one of the first electric potential and the second electric potential to each of the plurality of pixel electrodes, and by moving the electrophoretic particles by an electric field generated between the pixel electrodes and the common electrode,
wherein the image rewriting control includes
a first pulse application control for using the driving pulse signal with the pulse width thereof being a first width;
a low temperature pulse application control performed after the first pulse application control, in a case where the temperature determination circuit determines that the environmental temperature is lower than the predetermined threshold temperature; and
a second pulse application control for using the driving pulse signal with the pulse width thereof being a second width, performed at the end of the image rewriting control, and
wherein the driving pulse signal with the pulse width thereof being the first width is used in the low temperature pulse application control.

6. An electronic apparatus comprising the electrophoretic display device according to claim 5.
